(19) United States
(12) Patent Application Publication
(10) Pub. No.: US 2026/0346132 A1
(43) Pub. Date: Nov. 5, 2026

(54) COMPUTER-IMPLEMENTED METHOD, ONE OR MORE NON-TRANSITORY COMPUTER-READABLE STORAGE MEDIA, GAME APPARATUS, AND GAME SYSTEM

(71) Applicant: Nintendo Co., Ltd., Kyoto-shi (JP)

(72) Inventors: Takafumi MASAOKA, Kyoto (JP); Hideki FUJII, Kyoto (JP)

(21) Appl. No.: 19/710,007

(22) Filed: Jun. 16, 2026

Related U.S. Application Data
(63) Continuation of application No. PCT/JP2023/045688, filed on Dec. 20, 2023.

(51) Int. Cl. A63F 13/211; A63F 13/25

(52) U.S. Cl. CPC A63F 13/211; A63F 13/25

(57) ABSTRACT

First data based on movement of a mouse on a work surface is received, and second data based on the posture of the mouse is received. A virtual game object in a virtual space is accelerated in a specified direction when the first data indicates that the mouse is being moved in one of a forward direction and a backward direction on the work surface, and the course of the virtual game object being moved is changed when the second data indicates that the mouse is tilted in a roll direction.

### CROSS REFERENCE TO RELATED APPLICATION

This application is a continuation of International Application No. PCT/JP2023/45688, filed on Dec. 20, 2023, the entire contents of which are incorporated herein by reference.

### FIELD

The present disclosure relates to information processing.

### BACKGROUND AND SUMMARY

Conventionally, there has been known a game in which a mouse is used as an operation device.

A novel game in which a mouse is used as an operation device has been desired.

For example, the following configuration examples are provided.

One configuration example is directed to a computer-implemented method including: receiving first data based on incident light through an opening provided at a bottom surface of a mouse; receiving second data based on a posture of the mouse; accelerating a virtual game object in a virtual space in a specified direction, when the first data indicates that the mouse is being moved in one of a forward direction and a backward direction on a work surface; and changing the course of the virtual game object being moved, when the second data indicates that the mouse is tilted in a roll direction.

According to the above configuration example, it is possible to provide the user with a game having new entertainment characteristics, in which a virtual game object can be operated by novel and intuitive operations.

In another configuration example, the computer-implemented method may include reducing a degree of change in the course of the virtual game object in accordance with the second data, until a first condition is satisfied after the virtual game object is accelerated.

According to the above configuration example, when the user lifts the mouse to return the mouse to its position on the work surface after sliding the mouse in one direction, even if the mouse is unintentionally tilted, the degree to which the virtual game object changes its course against the user's intention can be reduced.

In another configuration example, the first condition may be satisfied by determining that the mouse is brought into contact with the work surface again after having been separated from the work surface.

A tilt of the mouse in the roll direction after the mouse has been moved on the work surface, lifted, and brought into contact with the work surface again, can be inferred to result from an intentional operation by the user. According to the above configuration example, in response to such an intentional tilting operation performed by the user, the course of the virtual game object can be smoothly changed.

In another configuration example, the first condition may be satisfied by elapse of a first specified time from a first timing after the virtual game object has been accelerated.

A tilt of the mouse in the roll direction after a specified time has elapsed since the mouse was moved on the work surface and then lifted, can be inferred to result from an intentional operation by the user. According to the above configuration example, in response to such an intentional tilting operation performed by the user, the course of the virtual game object can be smoothly changed.

In another configuration example, the computer-implemented method may include starting acceleration of the virtual game object, when the mouse is separated from the work surface.

According to the above configuration example, the timing at which the virtual game object actually accelerates can be intuitively controlled. Furthermore, for example, when the virtual game object is a skateboard, it is possible to provide a sense of operation similar to an experience of accelerating a real skateboard by kicking the ground.

In another configuration example, the computer-implemented method may include accelerating the virtual game object in the specified direction, when the first data indicates that the mouse is moved, on the work surface, within a specified angular range including an axis that extends in one of a forward direction and a backward direction of the mouse.

According to the above configuration example, even when the user performs a mouse movement operation in a direction deviating from the one direction described above, the virtual game object is accelerated, thereby enabling an easy movement operation.

In another configuration example, the computer-implemented method may include accelerating the virtual game object in the specified direction, in accordance with an absolute amount of movement of the mouse on the work surface, based on the first data.

According to the above configuration example, even when the user performs a mouse movement operation in a direction deviating from the one direction described above, the virtual game object is accelerated not only in response to the amount of movement in the one direction but also in response to the amount of movement resulting from the movement control (absolute amount). Thus, it is possible to prevent a sense of discomfort in which the virtual game object does not accelerate, or accelerates only slightly, relative to the distance of the movement operation.

In another configuration example, the computer-implemented method may include displaying, on a display unit, an acceleration-enabled parameter that enables acceleration of the virtual game object in accordance with a remaining amount thereof, the acceleration-enabled parameter being decreased when the virtual game object is accelerated and being recovered upon satisfaction of a second condition.

According to the above configuration example, acceleration of the virtual game object is restricted, thereby providing the user with entertainment characteristics in determining the necessity of acceleration.

In another configuration example, the computer-implemented method may include causing the virtual game object to perform a specified action, when the mouse is separated from the work surface during an operation input to an operation unit of the mouse.

According to the above configuration example, it is possible to distinguish, for example, between an operation of lifting the mouse to return the mouse to its position on the work surface and an operation of lifting the mouse to cause the virtual game object to perform a specified action, thereby preventing unintended user operations.

In another configuration example, the specified action may be a jump.

Since a jumping action is associated with an operation of lifting the mouse from the work surface, the above configuration example allows the virtual game object to jump through an intuitive operation.

In another configuration example, the computer-implemented method may include causing the virtual game object to enter a ready state during an operation input to the operation unit.

In another configuration example, the virtual game object may be a skateboarder, the ready state may be a crouching state, and, during the ready state, the skateboarder may have a greater degree of acceleration or a smaller degree of deceleration than when the virtual game object is not in the ready state.

According to the above configuration example, the user can intuitively understand that the crouching state corresponds to the ready state for jumping which is a specified action. In addition, the user can intuitively understand, from the crouching state, that the degree of acceleration of the virtual game object is large or the degree of deceleration of the virtual game object is small, thereby providing the user with entertainment characteristics as to whether or not to assume the crouching state.

In another configuration example, the computer-implemented method may include decelerating the virtual game object while the virtual game object is moving, when the second data indicates that the mouse has been rotated in a yaw direction.

According to the above configuration example, it is possible to provide the user with a game having new entertainment characteristics, in which a virtual game object can be operated by novel and intuitive operations.

In another configuration example, the virtual game object may be a skateboarder, and the method may include causing the skateboarder to kick the ground in the virtual space and causing the skateboarder to accelerate forward, when the first data indicates that the mouse is moved on the work surface in a backward direction.

Each configuration example described above may be read as a configuration example of one or more non-transitory computer-readable storage media, a game apparatus, or a game system.

### BRIEF DESCRIPTION OF THE DRAWINGS

FIG. 1 is a block diagram showing a non-limiting example of the internal configuration of a game apparatus 10;

FIG. 2 is a schematic diagram showing a non-limiting example of the appearance of a mouse;

FIG. 3 illustrates an operation method for the mouse;

FIG. 4 illustrates a non-limiting example of a game screen of a game;

FIG. 5 illustrates an operation method for the game;

FIG. 6 illustrates the operation method for the game;

FIG. 7 illustrates the operation method for the game;

FIG. 8 illustrates the operation method for the game;

FIG. 9 illustrates the operation method for the game;

FIG. 10 shows a non-limiting example of various data stored in a storage unit 12;

FIG. 11 is a non-limiting example of a flowchart of game processing;

FIG. 12 is a non-limiting example of a flowchart of the game processing;

FIG. 13 is a non-limiting example of a flowchart of the game processing; and

FIG. 14 shows a non-limiting example of an acceleration-enabled parameter.

### DETAILED DESCRIPTION OF NON-LIMITING EXAMPLE EMBODIMENTS

Hereinafter, an exemplary embodiment will be described.

### Hardware Configuration of Information Processing Apparatus

An information processing apparatus (information processing system) for executing information processing according to the exemplary embodiment will be described. The information processing apparatus is, for example, a stationary or hand-held game apparatus, a personal computer, a tablet terminal, a smartphone, a wearable terminal, or the like. The information processing apparatus according to the exemplary embodiment may be a server or may be composed of a game apparatus or the like as described above and a specified server. In the exemplary embodiment, a description will be given with a stationary game apparatus (sometimes referred to simply as “game apparatus”) as an example of the information processing apparatus.

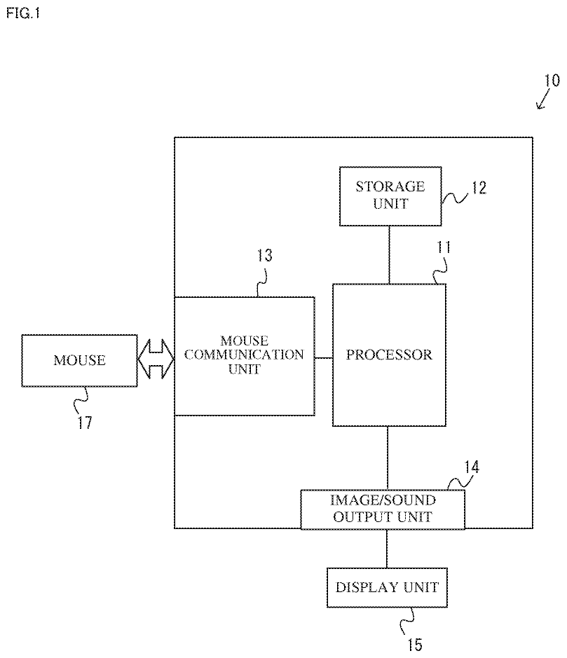

FIG. 1 is a block diagram showing an example of the internal configuration of a game apparatus (game system) 10 according to the exemplary embodiment. The game apparatus 10 includes a processor 11. The processor 11 is an information processing unit that executes various types of information processing to be executed in the game apparatus 10, and may, for example, be composed of only a CPU (Central Processing Unit) or be composed of a SoC (System-on-a-Chip) including a plurality of functions such as a CPU function and a GPU (Graphics Processing Unit) function. The processor 11 executes various types of information processing by executing an information processing program (e.g., a game program) stored in a storage unit 12. The storage unit 12 may be, for example, an internal storage medium such as a flash memory or a DRAM (Dynamic Random Access Memory) or may be configured to utilize an external storage medium mounted to a slot that is not shown, or the like.

The game apparatus 10 also includes a mouse communication unit 13 for performing wired communication or wireless communication with a mouse 17.

In addition, a display unit 15 (e.g., a television or the like) is connected to the game apparatus 10 via an image/sound output unit 14. The processor 11 outputs images and sounds generated (e.g., by executing the above information processing) to the display unit 15 capable of outputting sounds, via the image/sound output unit 14.

The game apparatus 10 also includes a network communication unit (not shown) and can communicate with external devices via a network. The network communication unit connects to a wireless LAN using a method compliant with, for example, the Wi-Fi standard, and performs Internet communication, etc., with external devices (other game apparatuses 10). In addition, the network communication unit can perform short-range wireless communication (e.g., infrared communication) with other game apparatuses 10.

The mouse 17 and the display unit 15 may be considered to be included in the game apparatus 10 or may be considered to not be included in the game device 10.

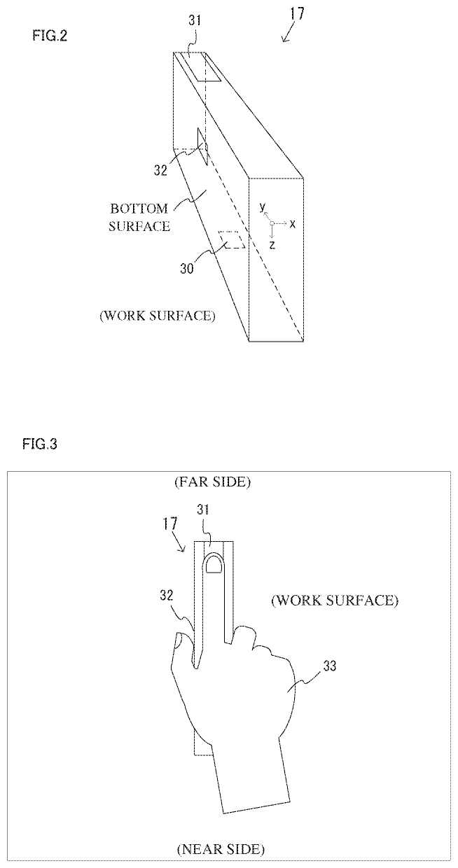

FIG. 2 is a schematic diagram showing an example of the appearance of the mouse 17. As shown in FIG. 2, the mouse 17 has a plate shape with a y-axis direction as a longitudinal direction (a rectangular parallelepiped shape in which the thickness in an x-axis direction is smaller than the thickness in a z-axis direction and the thickness in the z-axis direction is smaller than the thickness in the y-axis direction, or a shape similar thereto).

The mouse 17 includes an inertial sensor. Specifically, the mouse 17 includes an acceleration sensor (not shown) and an angular velocity sensor (not shown). A combination of the two sensors, i.e., the acceleration sensor and the angular velocity sensor, may be regarded as a single inertial sensor. The inertial sensor may further include another sensor. The acceleration sensor outputs data regarding the magnitudes of accelerations along three specified axes (x, y, and z axes shown in FIG. 2). The acceleration sensor may output data regarding an acceleration in one axial direction or accelerations in two axial directions. The angular velocity sensor outputs data regarding angular velocities around three specified axes (x, y, and z axes shown in FIG. 2). The angular velocity sensor may output data regarding an angular velocity around one axis or angular velocities around two axes. The output data from the acceleration sensor and the angular velocity sensor are repeatedly transmitted to the mouse communication unit 13 at appropriate timings. The data outputted from the inertial sensor may be used for calculating the posture, movement, rotation, etc., of the mouse 17.

As shown in FIG. 2 the mouse 17 includes a sensor (sometimes referred to as “mouse sensor”) 30 that detects, for example, an operation such as a user sliding the mouse 17 on a work surface (a work surface with which a bottom surface shown in FIG. 2 is in contact), on the bottom surface thereof. The mouse sensor 30 is, for example, a typical mouse sensor (e.g., an optical or laser sensor) that outputs data regarding incident light through an opening provided at the bottom surface. The outputted data may be used for calculating the movement (movement direction, movement distance, movement speed, current coordinates, etc.) on the work surface of the mouse 17. Moreover, as shown in FIG. 2, the mouse 17 includes a button 31 and a button 32. Data indicating the operation states of the button 31 and the button 32 is repeatedly transmitted to the mouse communication unit 13 at appropriate timings. The mouse 17 may include other operation units in addition to or instead of the buttons. As an example, the mouse 17 may include an analog stick and a touch pad. In addition, the mouse 17 is provided with a vibration device (not shown) that vibrates the mouse 17.

FIG. 3 illustrates an operation method for the mouse 17. As shown in FIG. 3, the user holds the mouse 17 with the right hand 33. Then, as shown in FIG. 3, the user can perform an operation of moving the mouse 17 on the work surface, can press the button 31 with the index finger or the middle finger, and can press the button 32 with the thumb. In addition, the user can perform, for example, an operation of lifting the mouse 17 from the work surface.

The mouse 17 is a right-handed mouse in which the button 32 is arranged at a position that can be easily pressed by the user's right thumb. Hereinafter, a case where the user operates the mouse 17 with the right hand will be described. When the user operates the mouse 17 with the left hand, a left-handed mouse (not shown) may be used instead of the right-handed mouse 17. The left-handed mouse is different from the right-handed mouse 17 in that a button 32 is arranged at a position that can be easily pressed by the user's left thumb (the position indicated by reference numeral 32 when FIG. 3 is horizontally reversed).

The work surface of the mouse 17 may not necessarily be flat. For example, the user may use the upper surface (front surface) of his/her thigh as the work surface for the mouse 17.

### Game Assumed in Exemplary Embodiment

Next, the outline of game processing executed by the game apparatus 10 according to the exemplary embodiment will be described. A game assumed in the exemplary embodiment is, as an example, a skateboard game. Specifically, in the game, a player object 100 (skateboarder, which may or may not include a skateboard; hereinafter also referred to as “PO”) which is operated in accordance with a user operation, moves in a virtual space and achieves a specified objective (e.g., reaching a goal location as quickly as possible). In addition, in this game, the PO 100 may pass through check points and acquire coins.

### Outline of Game Processing of Exemplary Embodiment

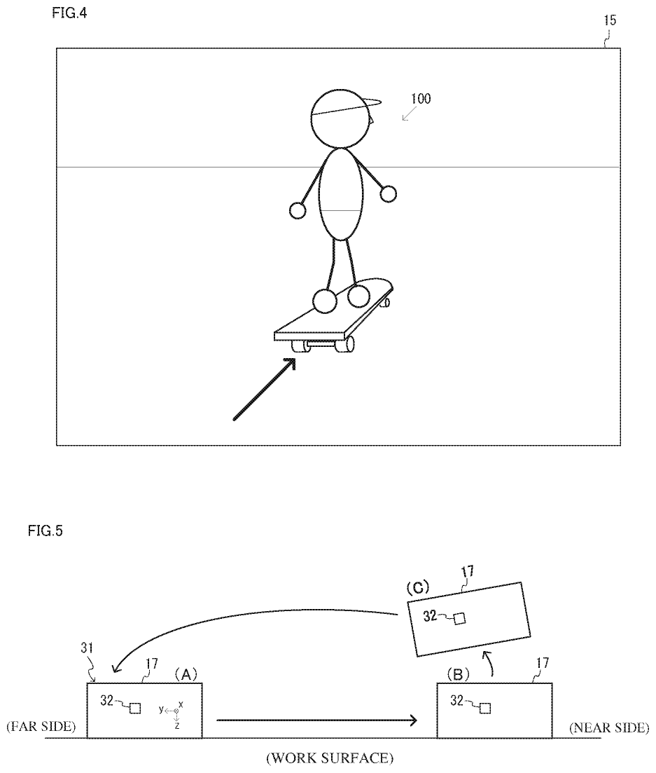

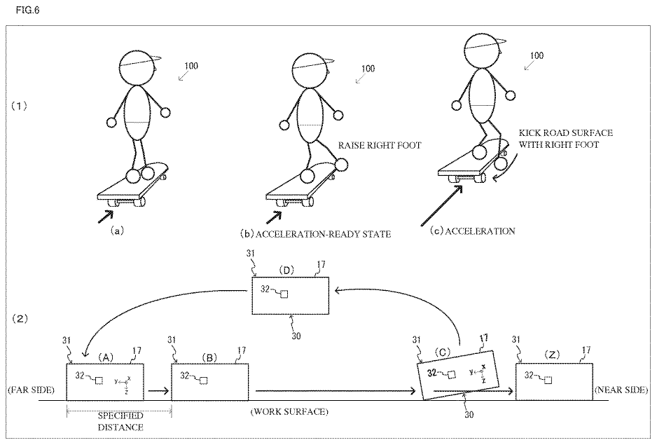

Next, the outline of operation of the game processing executed by the game apparatus 10 according to the exemplary embodiment will be described. FIG. 4 illustrates an example of a game image obtained by rendering the virtual space of this game. As shown in FIG. 4, the PO 100 can move on a ground object (sometimes referred to as “ground” or “road surface”) in the forward direction (the front of the skateboard) in response to an operation performed by the user. The PO 100 is also affected by air resistance, road surface resistance, or the like (sometimes simply referred to as “resistance”). Specifically, due to such resistance, a force is applied to the PO 100 in a direction that decelerates the PO 100 according to its movement speed or the like. The PO 100 is also affected by tilting of the road surface. Specifically, a force corresponding to the angle of a slope is applied to the PO 100 in the downslope direction. Therefore, the PO 100 is accelerated or decelerated due to the influence of the slope. The traveling direction of the PO 100 may be changed toward a direction in which the angle of the slope becomes greater.

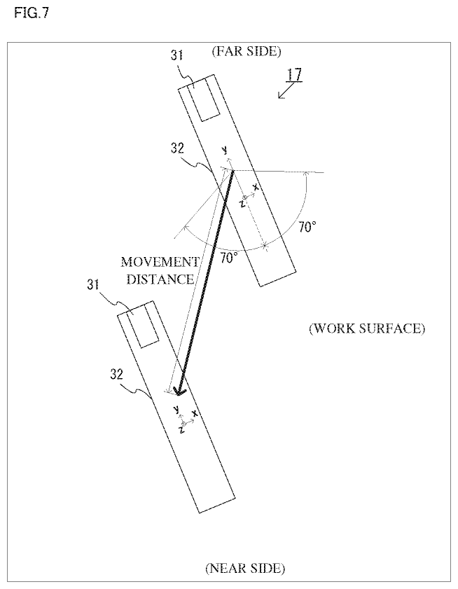

FIG. 5 illustrates the outline of an operation for accelerating the PO 100 in the forward direction. In FIG. 5 and subsequent figures, the hand of the user operating the mouse 17 is not shown. As shown in FIG. 5, by moving the mouse 17 toward the user (in the y-axis negative direction) on the work surface (see (A), (B)) and then lifting the mouse 17 from the work surface (see (C)), the user can accelerate the PO 100 in the forward direction (the direction in which the skateboard moves forward). Therefore, the PO 100 can be moved forward through intuitive operations. By repeatedly placing the lifted mouse 17 back onto the work surface, moving the mouse 17 again toward the user (see (A), (B)), and then lifting the mouse 17 from the work surface (see (C)), the user can repeatedly accelerate the PO 100 in the forward direction. Therefore, even if the PO 100 decelerated while moving, the user can continuously move the PO 100 forward.

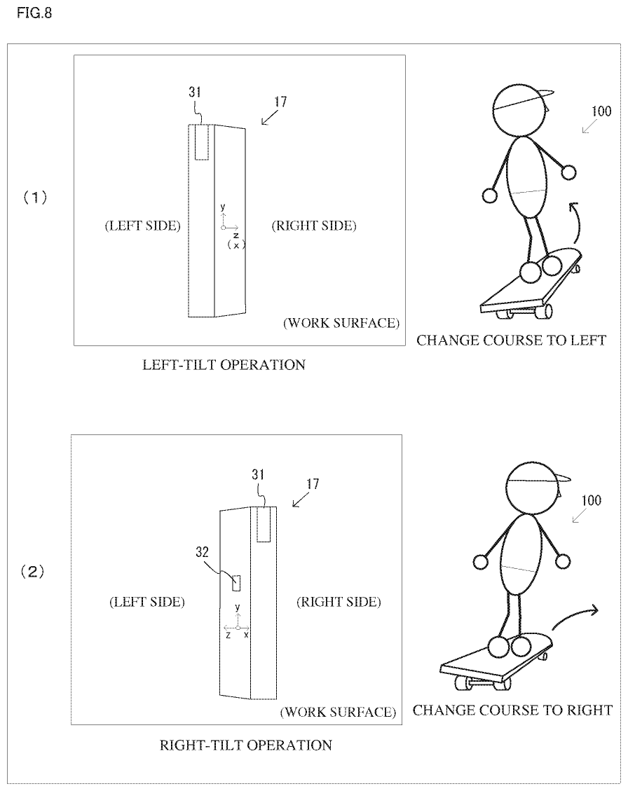

FIG. 6(1) specifically illustrates an operation for accelerating the PO 100 in the forward direction. FIG. 6(2) specifically illustrates a mouse operation for accelerating the PO 100 in the forward direction. In FIG. 6(2), (A) indicates a point in time at which the mouse 17 starts to move on the work surface in the direction toward the user (in the y-axis negative direction), (B) indicates a point in time at which the mouse 17 has moved from (A) toward the user on the work surface by a specified distance (e.g., 2 cm; for convenience of illustration, the distance between (A) and (B) is shown as larger than actual), and (C) indicates a point in time at which the mouse 17, having moved further toward the user from (B) on the work surface, is lifted from (separated from) the work surface. Furthermore, (D) indicates a point in time at which the lifted mouse 17 is moving toward the far side in the air in order to perform again the operation of moving the mouse 17 toward the user on the work surface. Moreover, (Z) indicates a point in time at which the mouse 17, having moved further toward the user from (B), remains on the work surface without being lifted for a specified period (e.g., 0.5 seconds) after (B). Although (Z) is illustrated closer to the user than (C) in FIG. 6(2), the position of (Z) has no particular significance.

First, it is assumed that when the mouse 17 is at time point (A), the PO 100 is moving forward by inertia, as shown in (a) of FIG. 6(1). Thereafter, at time point (B), when the mouse 17 has moved a specified distance toward the user on the work surface from time point (A), the PO 100 enters an acceleration-ready state in which the right foot is raised, as shown in (b) of FIG. 6(1). Thereafter, at time point (C), when the mouse 17 has moved toward the user on the work surface from time point (B) and has been lifted from the work surface, the PO 100 accelerates forward by kicking the road surface with the right foot, as shown in (c) of FIG. 6(1). In this case, the PO 100 accelerates to a degree corresponding to the distance by which the mouse 17 moves from time point (B) to time point (C). In other embodiments, the PO 100 may accelerate to a degree corresponding to the distance by which the mouse 17 moves from time point (A) to time point (C), or the degree of acceleration may be constant. Thereafter, if the user desires to accelerate the PO 100 again, the user moves the lifted mouse 17 toward the far side in the air (see (D)), places the mouse 17 on the work surface (i.e., brings the mouse 17 into contact with the work surface again; see (A)), and performs the above-described operation again.

Through the above operations, the user can accelerate (or repeatedly accelerate) the PO 100. As described above, the PO 100 accelerates by kicking the road surface at the time point when the mouse 17 is moved toward the user and then lifted from the work surface. Therefore, it is possible to provide the user with a sense of operation as if accelerating the PO 100 by kicking the road surface with the mouse 17 (a sense of operation of accelerating a real skateboard by kicking the ground).

On the other hand, even at time point (Z), which is a specified time (e.g., 0.5 seconds) after time point (B), the PO 100 accelerates in the forward direction by kicking the road surface with the right foot, as shown in (c) of FIG. 6(1). In this case, the PO 100 may accelerate to a degree corresponding to the distance by which the mouse 17 moves from time point (B) to time point (Z). In other embodiments, the PO 100 may accelerate to a degree corresponding to the distance by which the mouse 17 moves from time point (A) to time point (Z), or the degree of acceleration may be constant. Thus, since the PO 100 accelerates forward by kicking the road surface after a specified time has elapsed, it is possible to provide a sense of operation that is close to the acceleration motion of a real skateboard, in which acceleration is achieved by quickly kicking the road surface for a short time.

In the exemplary embodiment, whether the mouse 17 is located on the work surface (whether the mouse is in contact with the work surface) is determined depending on whether the mouse sensor 30 detects the work surface. However, the determination method is not limited thereto. For example, whether the mouse is in contact with the work surface may be determined depending on whether a button provided at the bottom surface of the mouse 17 is pressed. Alternatively, whether the mouse is in contact with the work surface may be determined by measuring the distance to the work surface with a distance sensor provided at the bottom surface of the mouse 17.

FIG. 7 illustrates the movement distance of the mouse 17 when the mouse 17 is moved toward the user on the work surface. The user does not necessarily hold the mouse 17 such that the y-axis of the mouse 17 is orientated straight toward the far side. As shown in FIG. 7, the user may hold the mouse 17 while it is tilted in a yaw direction. Furthermore, when pulling the mouse 17 toward the user, the user does not necessarily move the mouse 17 straight in the direction toward the user. As shown in FIG. 7, the user may move the mouse 17 slightly in an oblique direction. Therefore, when the user performs an acceleration operation by moving the mouse 17 toward the user, it is assumed that, as viewed from the mouse 17, the mouse 17 is moved in a direction that deviates from the y-axis negative direction. Therefore, in the exemplary embodiment, a movement operation of the mouse 17 in a direction that falls within a specified angular range including the y-axis in the xy-plane is regarded as an operation for accelerating the PO 100, and the PO 100 is accelerated. In FIG. 7, as an example, a movement operation of the mouse 17 in a direction within a range of 70 degrees to the left and right centered on the y-axis in the xy-plane, is regarded as an operation for accelerating the PO 100. As a result, as shown in FIG. 7, even when the user moves the mouse 17 in a direction that deviates to a certain extent from the y-axis negative direction, the PO 100 is accelerated.

In the exemplary embodiment, when the mouse 17 is moved toward the user on the work surface, the movement distance of the mouse 17 is defined as an absolute movement distance, rather than the movement distance only in the y-axis direction. Specifically, as shown in FIG. 7, it is the movement distance in the xy-plane. In this case, as shown in FIG. 7, even when the user moves the mouse 17 in an oblique direction with respect to the y-axis negative direction, the PO 100 is accelerated by an amount corresponding to the absolute movement distance of the mouse 17. As a result, it is possible to prevent a sense of discomfort in which the PO 100 does not move, or accelerates only slightly, despite movement of the mouse 17.

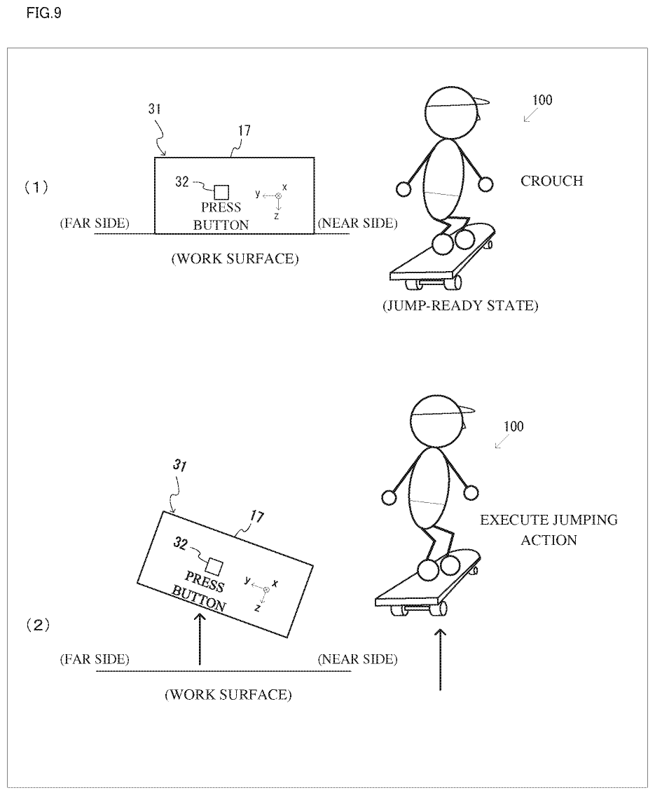

FIG. 8 illustrates an operation for causing the PO 100 to change its course while moving. As shown in FIG. 8(1), in response to an operation of tilting the mouse 17 to the left (sometimes referred to as “left-tilt operation”), the PO 100 tilts its body to the left and changes its course in the leftward direction to a degree corresponding to the degree (angle) of the left-tilt operation. FIG. 8(2) shows, conversely, an example in which, in response to an operation of tilting the mouse 17 to the right (sometimes referred to as “right-tilt operation”), the PO 100 tilts its body to the right and changes its course in the rightward direction to a degree corresponding to the degree of the right-tilt operation. In the exemplary embodiment, the PO 100 curves further to the left as the degree of the left-tilt operation increases, and curves further to the right as the degree of the right-tilt operation increases. The example of course change is not limited to that described above. In other embodiments, the PO 100 may change its course not by curving to change its direction of travel, but by sliding laterally while maintaining its direction of travel.

The left-tilt operation and the right-tilt operation (sometimes collectively referred to as “tilt operation”) are detected by the inertial sensor included in the mouse 17. The tilt operations may be detected by using the angular velocity sensor, or both the acceleration sensor and the angular velocity sensor. The tilt operation is an operation of tilting the mouse 17 in a roll rotation direction (rotation direction around the y-axis), and therefore may be referred to as “tilting operation in the roll direction”.

For example, a posture in which the z-axis of the mouse 17 is perpendicular to the work surface may be set as an initial posture, and a tilt from the initial posture may be detected as a tilt caused by a tilt operation. With this configuration, even when the work surface is tilted (i.e., a work surface that is not orthogonal to the direction of gravitational acceleration), it is possible to prevent the PO 100 from unintentionally changing its course.

In the exemplary embodiment, there are cases where a course change of the PO 100 is not performed even when a tilt operation is performed. That is, the course change may be restricted. Specifically, from the time point when the PO 100 accelerates (see (C), (Z) in FIG. 6(2)) until the mouse 17 is again brought into contact with the work surface (i.e., changes from a non-contact state to a contact state) or until a specified time (e.g., 0.5 seconds) has elapsed, the course change of the PO 100 is restricted so as not to be performed even if a tilt operation is performed. With this configuration, when the PO 100 is accelerated at (C) in FIG. 6(2), it is possible to prevent a situation in which the mouse 17 that has been lifted (see (D) in FIG. 6(2)) unintentionally tilts in the roll direction, causing the PO 100 to unintentionally change its course. In addition, after the mouse 17 is again brought into contact with the work surface (see (A) in FIG. 6(2)), an intentional tilt operation can be smoothly reflected, thereby allowing the PO 100 to change its course. Furthermore, even when the mouse 17 is not brought into contact with the work surface again, it is likely that an intentional tilt operation is performed after a certain amount of time has elapsed since the PO 100 was accelerated. Therefore, after the specified time has elapsed, the restriction on course change is released, thereby allowing the PO 100 to change its course.

In other embodiments, the course change may be restricted from the time point when the mouse 17 starts to move toward the user on the work surface (see (A) in FIG. 6(2)). Alternatively, the course change may be restricted from the time point when the mouse 17 is brought into contact with the work surface (i.e., the time point when contact starts; see (D) to (A) in FIG. 6(2)). Furthermore, although the course change of the PO 100 is fully restricted in the exemplary embodiment, in other embodiments, the course change of the PO 100 may be partially restricted so as to reduce the degree thereof, instead of fully restricting the course change. For example, while the course change is restricted, the course change may be restricted such that only half of the degree of course change that will normally be applied is applied with respect to the degree of tilt of the mouse 17, or the upper limit of the degree of course change may be reduced.

FIG. 9 illustrates an operation for causing the PO 100 to crouch and an operation for causing the PO 100 to jump. As shown in FIG. 9(1), when the button 32 continues to be pressed while the PO 100 is not jumping, the PO 100 assumes a crouching posture (sometimes referred to as “jump-ready state”). The PO 100 can avoid obstacles by assuming a crouching posture (e.g., by passing under an obstacle). In the crouching posture, air resistance is reduced, and therefore the force due to air resistance that decelerates the PO 100 while moving is smaller than in an upright posture. In other words, the degree of deceleration is reduced. Even when the button 32 is in a pressed state, if the acceleration operation described with reference to FIG. 6 is performed, the PO 100 may accelerate by kicking the road surface while being in the crouching posture. Furthermore, when the button 32 is in a pressed state and the course change operation described with reference to FIG. 8 is performed, the PO 100 may change its course while being in the crouching posture. If the mouse 17 includes, for example, an analog stick, the PO 100 may assume a crouching posture when the analog stick is tilted. Furthermore, in the exemplary embodiment, the PO 100 assumes the crouching posture during the period in which the button 32 is pressed. However, in other embodiments, the PO 100 may assume the crouching posture when the button 32 is pressed once, and may return to an upright posture when the button 32 is pressed once again while the PO 100 is in the crouching posture.

When the mouse 17 is lifted while the button 32 is in a pressed state (jump-ready state), the PO 100 jumps. Thus, the PO 100 can jump over obstacles or pass through rings. Detection of the mouse 17 being lifted may be performed by, for example, detecting, using the inertial sensor, a change in acceleration which is equal to or greater than a specified value in the z-axis direction. Detection of the mouse 17 being lifted may be performed by detecting, using the mouse sensor 30, that the mouse 17 enters a non-contact state, or may be performed by both the detection using the inertial sensor and the detection using the mouse sensor 30. As described above, by causing the PO 100 to jump in response to an operation in which the mouse 17 is lifted while the button 32 is in a pressed state (crouching posture), it is possible to prevent the PO 100 from unintentionally jumping when the mouse is lifted during an acceleration operation (see FIG. 6).

### Details of Information Processing of Exemplary Embodiment

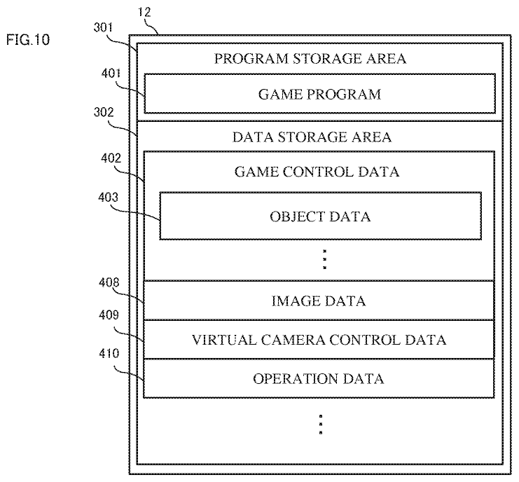

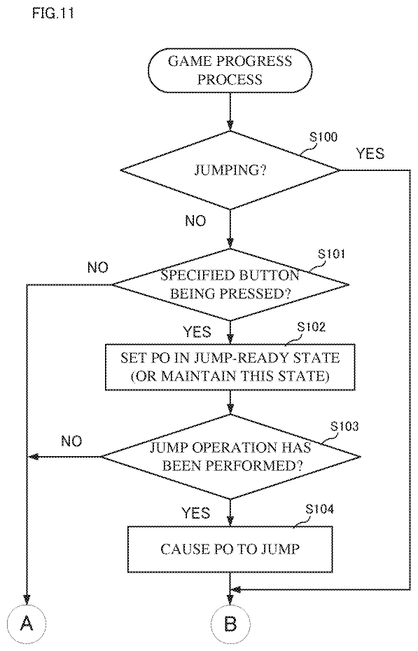

Next, the information processing of the exemplary embodiment will be described in detail with reference to FIG. 10 to FIG. 13.

### Data to be Used

Various data to be used in this game processing will be described. FIG. 10 shows an example of data stored in the storage unit 12 of the game apparatus 10. As shown in FIG. 10, the storage unit 12 is provided with at least a program storage area 301 and a data storage area 302. A game program 401 is stored in the program storage area 301. In the data storage area 302, game control data 402, image data 408, virtual camera control data 409, operation data 410, etc., are stored. The game control data 402 includes object data 403.

The game program 401 is a game program for executing the game processing.

The object data 403 is data of objects to be arranged in the virtual space, such as a player object, a ground (road surface) object, an enemy object, etc. The object data 403 also includes data of the coordinates, orientation, posture, state, etc., of each object.

The image data 408 is image data of the background, virtual effects, etc.

The virtual camera control data 409 is data for controlling the movement of a virtual camera to be placed in the virtual space.

The operation data 410 is data indicating the contents of operations performed on the mouse 17. The operation data 410 includes, for example, data indicating the movements (including movements on the work surface) and posture changes of the mouse 17, and input states for pressed states of various buttons, etc. The contents of the operation data are updated at a specified cycle, based on data outputted from the mouse 17.

In addition, various data to be used in the game processing and rendering processing are stored in the storage unit 12 as necessary.

### Details of Game Processing

Next, the game processing according to the exemplary embodiment will be described with reference to flowcharts. FIG. 11 to FIG. 13 are examples of flowcharts showing the game processing according to the exemplary embodiment. Hereinafter, processing characteristics of the exemplary embodiment will be described, and the description for other processing is omitted. For example, the description of processing of reflecting the reception data 410, rendering processing, processing of transmitting the transmission data, etc., is omitted.

When the game processing is started and a skateboard game is started, a game progress process shown in FIG. 11 to FIG. 13 is started. This process is executed at specified intervals (e.g., every rendering frame). When the skateboard game ends, the game processing ends.

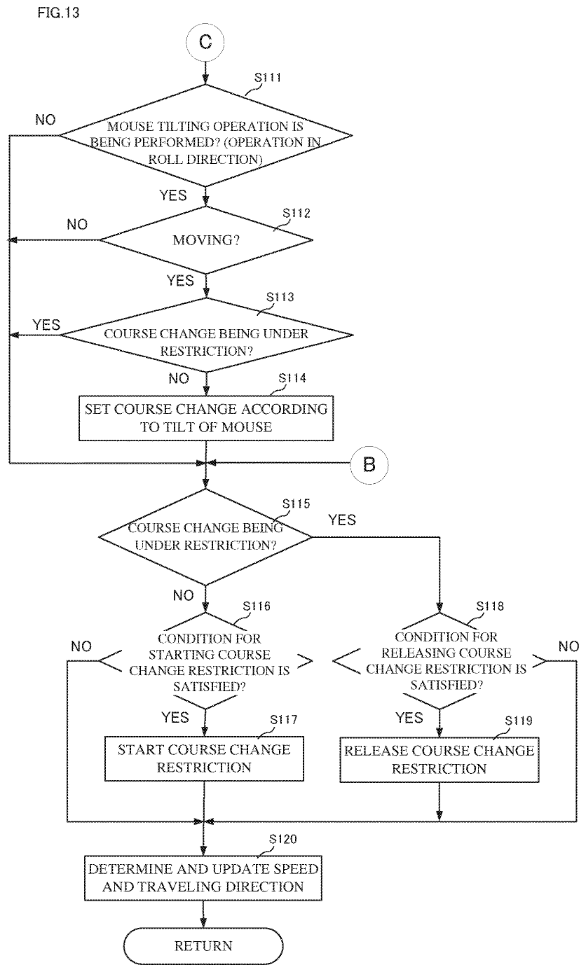

First, in step S100 in FIG. 11, based on the object data 403, the processor 11 determines whether the PO 100 is jumping (see FIG. 9(2)). When this determination is YES, the processing proceeds to step S115 in FIG. 13. When this determination is NO, the processing proceeds to step S101.

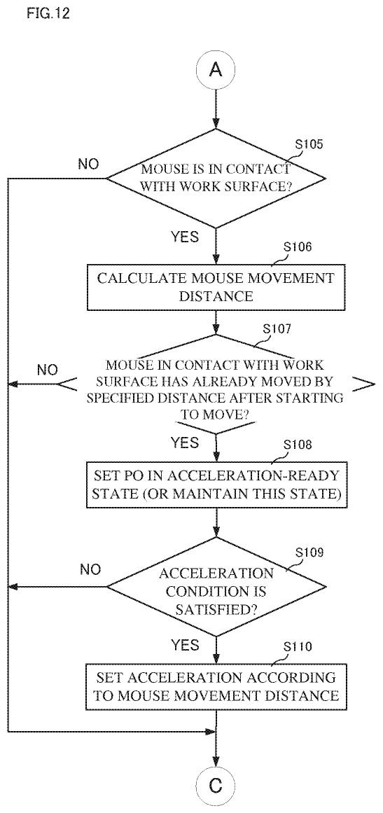

In step S101, based on the operation data 410, the processor 11 determines whether a specified button (button 32) is being pressed. When this determination is YES, the processing proceeds to step S102. When this determination is NO, the processing proceeds to step S105 in FIG. 12.

In step S102, as described with reference to FIG. 9(1), the processor 11 sets the PO 100 in the jump-ready state (if the PO 100 is already in the jump-ready state, the jump-ready state is maintained). Thereafter, the processing proceeds to step S103.

In step S103, based on the operation data 410, the processor 11 determines whether a jump operation that is described with reference to FIG. 9(2) has been performed. When this determination is YES, the processing proceeds to step S104. When this determination is NO, the processing proceeds to step S105 in FIG. 12.

In step S 104, as described with reference to FIG. 9(2), the processor 11 causes the PO 100 to jump. Thereafter, the processing proceeds to step S115 in FIG. 13.

In step S105 in FIG. 12, based on the operation data 410, the processor 11 determines whether the mouse 17 is in contact with the work surface. When this determination is YES, the processing proceeds to step S106. When this determination is NO, the processing proceeds to step S111 in FIG. 13.

In step S106, the processor 11 calculates a movement distance of the mouse 17, based on the operation data 410. Specifically, as described with reference to FIG. 6 and FIG. 7, the processor 11 calculates a movement distance from (A) in FIG. 6(2). Then, the processing proceeds to step S107.

In step S107, the processor 11 determines whether the mouse 17, which is in contact with the work surface, has moved a specified distance (e.g., 2 cm) from the time when it started moving. Specifically, based on the movement distance calculated in step S106, the processor 11 determines whether the mouse 17 has moved from (A) to (B) in FIG. 6(2). When this determination is YES, the processing proceeds to step S108. When this determination is NO, the processing proceeds to step S111 in FIG. 13.

In step S108, as described with reference to FIG. 6(1), the processor 11 sets the PO 100 in the acceleration-ready state (if the PO 100 is already in the acceleration-ready state, the acceleration-ready state is maintained). Then, the processing proceeds to step S109.

In step S109, the processor 11 determines whether an acceleration condition is satisfied. Specifically, as described with reference to FIG. 6, the processor 11 determines whether the mouse 17 in the acceleration-ready state has been lifted from the work surface (has entered the non-contact state; (C) in FIG. 6(2)) or whether a specified time (e.g., 0.5 seconds) has elapsed from when the mouse 17 entered the acceleration-ready state ((Z) in FIG. 6(2)). When this determination is YES, the processing proceeds to step S110. When this determination is NO, the processing proceeds to step S111 in FIG. 13.

In step S110, as described with reference to FIG. 6 and FIG. 7, the processor 11 sets an acceleration of the PO 100 in accordance with the movement distance of the mouse 17 (movement distance from (B) to (C) or (Z) in FIG. 6(2)). Then, the processing proceeds to step S111 in FIG. 13.

In step S111 in FIG. 13, based on the operation data 410, the processor 11 determines whether the tilt operation in the roll direction of the mouse 17, which is described with reference to FIG. 8, is being performed. When this determination is YES, the processing proceeds to step S112. When this determination is NO, the processing proceeds to step S115.

In step S112, based on the object data 403, the processor 11 determines whether the PO 100 is moving (traveling forward). When this determination is YES, the processing proceeds to step S113. When this determination is NO, the processing proceeds to step S115.

In step S113, based on the operation data 410, etc., the processor 11 determines whether the processing is currently under the course change restriction described with reference to FIG. 6. When this determination is YES, the processing proceeds to step S115. When this determination is NO, the processing proceeds to step S114.

In step S114, based on the operation data 410, the processor 11 sets a course change of the PO 100 in accordance with a tilt in the roll direction of the mouse 17. Then, the processing proceeds to step S115.

In step S115, as in step S113, the processor 11 determines whether the processing is currently under the course change restriction. When this determination is YES, the processing proceeds to step S118. When this determination is NO, the processing proceeds to step S116.

In step S116, based on the operation data 410, etc., the processor 11 determines whether the condition for starting the course change restriction is satisfied. Specifically, the processor 11 determines whether the PO 100 has accelerated (see (C), (Z) in FIG. 6(2)). When this determination is YES, the processing proceeds to step S117. When this determination is NO, the processing proceeds to step S120.

In step S117, the processor 11 starts the course change restriction. Then, the processing proceeds to step S120.

In step S118, based on the operation data 410, etc., the processor 11 determines whether the condition for releasing the course change restriction is satisfied. Specifically, as described with reference to FIG. 6, the processor 11 determines whether a specified time has elapsed from when the mouse 17 was again brought into contact with the work surface or when the course change restriction was started. When this determination is YES, the processing proceeds to step S119. When this determination is NO, the processing proceeds to step S120.

In step S119, the processor 11 releases (ends) the course change restriction. Thereafter, the processing proceeds to step S120.

In step S120, the processor 11 determines the movement speed and the traveling direction of the PO 100, and updates the movement state of the PO 100. Specifically, when the PO 100 is not in a jumping state, the processor 11 determines the movement speed and the traveling direction of the PO 100, based on the acceleration set in step S110, the content of the course change set in step S114, the resistance, and the tilt of the road surface, and updates the movement state of the PO 100. For example, when the road surface is tilted laterally with respect to the traveling direction of the PO 100, the traveling direction of the PO 100 may be determined so as to curve toward the downward-tilted side. The processor 11 may reduce the air resistance when the PO 100 is in a crouching posture. Furthermore, when the PO 100 is jumping, the processor 11 determines the movement speed of the PO 100, based on the air resistance, and updates the movement state of the PO 100. When the PO 100 is jumping, the processor 11 may ignore the road surface resistance. The processor 11 may determine the movement speed and the traveling direction of the PO 100, based on the tilt of the road surface at the moment when the PO 100 jumps. Thereafter, the processing proceeds to step S100.

According to the exemplary embodiment described above, as described with reference to FIG. 6, by moving the mouse 17 toward the user and then lifting the mouse 17 from the work surface, the PO 100 can be caused to kick the road surface and accelerate. As a result, it is possible to provide the user with a sense of operation as if the user is accelerating by kicking the road surface with the mouse 17 (a sense of operation similar to accelerating a real skateboard by kicking the road surface). Furthermore, as described with reference to FIG. 8, by tilting the mouse 17 in the roll direction, the PO 100 can be caused to lean its body and perform a course change. As a result, it is possible to provide the user with a sense of operation as if the user leans its body on a real skateboard to perform a course change. Moreover, as described with reference to FIG. 9, the PO 100 can be caused to jump by pressing the button 32 to make the PO 100 crouch and then lifting the mouse 17. As a result, it is possible to provide the user with a sense of operation as if the user crouches and then jumps on a real skateboard.

### Modifications

In the above exemplary embodiment, as described with reference to FIG. 6, the PO 100 accelerates at the time point (C) or (Z) after the mouse 17 has moved toward the user. However, the condition for starting acceleration may be either one of the above conditions, or may be another condition. For example, the PO 100 may accelerate when the movement distance of the mouse 17 has reached a specified value.

In the above exemplary embodiment, although it is possible to cause the PO 100 to perform a course change by tilting the mouse even while the mouse 17 is being moved toward the user, such a course change may be prohibited in this case. That is, the user may not necessarily achieve acceleration and a course change of the PO 100 at the same time. In this case, the user is required to select, for example, immediately before entering a curve, whether to accelerate the PO 100 or to change the course of the PO 100, thereby introducing strategic elements into the game.

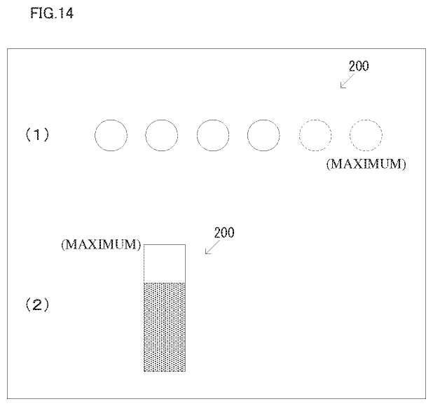

In the above exemplary embodiment, no limitation is imposed on the number of times of acceleration of the PO 100 described with reference to FIG. 6, etc. However, a limitation may be imposed on the number of times of acceleration of the PO 100. For example, an acceleration-enabled parameter 200, which decreases in conjunction with acceleration of the PO 100 and recovers upon satisfaction of a specified condition, may be displayed on the display unit 15, and the PO 100 can be accelerated in response to an acceleration operation when the acceleration-enabled parameter 200 remains. FIG. 14 shows an example of the acceleration-enabled parameter 200. The acceleration-enabled parameter 200 shown in FIG. 14(1) is configured such that, with each single acceleration of the PO 100, one out of a maximum of six circular indications is reduced. The acceleration-enabled parameter 200 shown in FIG. 14(2) is configured such that, with each single acceleration of the PO 100, the energy used for acceleration (the value on the graph) decreases by a specified amount. The acceleration-enabled parameter 200 may recover with the passage of time. For example, if acceleration is not performed for a specified period, the acceleration-enabled parameter 200 may recover by one circular indication (or by a specified amount) at a time, or may recover to its maximum value. For example, the acceleration-enabled parameter 200 may recover by one circular indication (or by a specified amount) at a time in accordance with the passage of time regardless of whether acceleration is performed, or may recover to its maximum value. For example, the acceleration-enabled parameter 200 may recover when the PO 100 acquires a specified item, or may recover when the PO 100 performs a specific action (such as a jump).

In the above exemplary embodiment, when the PO 100 is not accelerated, the PO 100 may come to a stop, or may continue moving, for example, at a specified low speed.

In the above exemplary embodiment, the PO 100 may decelerate in response to a specified operation. For example, in the case where the mouse 17 includes an analog stick, if it is detected that the analog stick has been tilted toward the user (in the y-axis negative direction), the PO 100 that is traveling may decelerate by taking a braking posture in which the front end of the skateboard is raised and the rear end is lowered. As another example, the PO 100 may take the braking posture when the y-axis positive side of the mouse 17 is lifted higher than the y-axis negative side.

In the above exemplary embodiment, the PO 100 may rapidly decelerate by performing a power slide in response to a specified operation. For example, when the inertial sensor detects that the mouse 17 has been rotated in the yaw direction (rotation direction about the Z-axis shown in FIG. 2) by a specific angle or more at a specific rotation speed or more, the PO 100 may rotate in the detected rotation direction such that a side surface of the skateboard faces the traveling direction, thereby causing the PO 100 to perform a power slide and rapidly decelerate. In the exemplary embodiment, if the above-described deceleration by braking is allowed, an operation of performing a power slide is different from the operation of performing braking, and deceleration by a power slide may be greater than the deceleration by braking.

In the above exemplary embodiment, the mouse 17 may be vibrated by a vibration device in accordance with movement of the PO 100. As an example, when the PO 100 is moving on the road surface, the mouse 17 may be vibrated, and when the PO 100 is separated from the road surface (when it is jumping) or when the PO 100 is stopped, the vibration may be stopped. In addition, the intensity or the like of the vibration of the mouse 17 may be varied in accordance with the condition of the road surface (e.g., asphalt, dirt, or gravel). Moreover, as an example, at the moment when the PO 100 kicks the road surface, the mouse 17 may be temporarily vibrated with a relatively large intensity. For example, while the PO 100 is moving on the road surface, a relatively weak vibration associated with the movement on the road surface may be continuously generated, and a relatively large vibration caused by kicking the road surface may be temporarily superimposed thereon.

In the above exemplary embodiment, the PO 100 may carry a weapon (rifle, bow and arrow, sword, etc.), and the PO 100 may use the weapon in response to a specified operation. As an example, the PO 100 may be ready with the weapon in response to an operation of raising the mouse 17. For example, when the inertial sensor detects that an angular difference between the y-axis negative direction of the mouse 17 (see FIG. 2) and the direction of gravitational acceleration is within a specified angle (e.g., 30 degrees), the PO 100 may be ready with the weapon. Furthermore, when the PO 100 is in the weapon-ready state and the inertial sensor detects, for example, that the mouse 17 has been swung with an acceleration or an angular velocity equal to or greater than a specified value, the PO 100 may use the weapon to attack, for example, an enemy object.

In the above exemplary embodiment, after the mouse 17 is lifted from the work surface and the PO 100 jumps (see FIG. 9), if the mouse 17 is suddenly returned toward the work surface (e.g., if the inertial sensor detects an acceleration change in the z-axis direction equal to or greater than a specified value), the PO 100 may perform a specified action. For example, the PO 100 may perform a somersault and land, or may stomp on an enemy object to inflict damage.

In the above exemplary embodiment, the PO 100 is caused to change its course in response to a tilt operation in the roll direction of the mouse 17 (see FIG. 8). However, for example, the PO 100 may be caused to change its course in response to sliding of the mouse 17 in the x-axis direction (left-right direction). For example, the PO 100 may be caused to change its course by laterally sliding the PO 100. Furthermore, the PO 100 may attack an enemy object and inflict damage by changing its course through such lateral sliding. Moreover, in response to sliding movement of the mouse 17 in the x-axis direction, an enemy object located beside the PO 100 may be attacked and damaged, without causing the PO 100 to perform lateral sliding.

In the above exemplary embodiment (see FIG. 2), the mouse sensor 30 outputs data regarding reflected light from the work surface. Based on the data, the processor 11 of the game apparatus 10 determines whether the mouse has moved on the work surface, and calculates the movement direction, movement amount, etc. However, the mouse 17 may determine whether the mouse 17 has moved on the work surface and calculate the movement direction, movement amount, etc., based on the data outputted from the mouse sensor 30, and may transmit the resultant to the game apparatus 10. That is, the mouse 17 may transmit data regarding the movement amount of the mouse, as data based on reflected light from the work surface. Such data calculation may be performed by a processor included in the mouse 17, or may be performed by the mouse sensor 30. The processor 11 of the game apparatus 10 or the mouse 17 may calculate the current position of the mouse in the mouse coordinate system, as data based on reflected light from the work surface. The same applies to the inertial sensor included in the mouse, and calculation of an actual posture and the like may be performed by either the game apparatus 10 or the mouse 17.

The shape of the mouse 17 (see FIG. 2) in the above exemplary embodiment is merely an example. For example, the mouse 17 may include a grip that is easy for the user to hold and lift. As an example, the mouse 17 may be used like a general game controller. That is, a game controller including a mouse sensor 30 is included in the scope of the mouse in the present disclosure. Moreover, the mouse 17 may be attachable to and detachable from other devices. In other embodiments, a mouse may include, on its surface, a ball that can be rotationally operated. In this case, instead of or in addition to the operation of movement on the work surface, the mouse may output substantially the same data as that when the mouse is moved on the work surface, by rotating the ball as desired. Game processing may be executed based on such data acquired from the mouse.

In the above exemplary embodiment, a skateboard game has been exemplified; however, other games may also be adopted. For example, the PO 100 may be a human, snowboarder, automobile, boat, airplane, or the like. For example, when the PO 100 is a rotating body such as a tire, the rotating body may move forward in response to the mouse 17 being moved from the near side toward the far side.

In the exemplary embodiment, a case in which a series of processes regarding the game processing are executed in the single game apparatus 10 has been described. In another exemplary embodiment, the series of processes may be executed in an information processing system including a plurality of information processing apparatuses. For example, in an information processing system including a terminal-side apparatus and a server-side apparatus communicable with the terminal-side apparatus via a network, some of the series of processes above may be executed by the server-side apparatus. Further, in an information processing system including a terminal-side apparatus and a server-side apparatus communicable with the terminal-side apparatus via a network, major processes among the series of processes above may be executed by the server-side apparatus, and some of the processes may be executed in the terminal-side apparatus. Further, in the above information processing system, the system on the server side may be implemented by a plurality of information processing apparatuses, and processes that should be executed on the server side may be shared and executed by a plurality of information processing apparatuses. Further, a configuration of so-called cloud gaming may be adopted. For example, a configuration may be adopted in which: the game apparatus 10 sends operation data indicating operations performed by the user to a specified server; various game processes are executed in the server; and the execution result is streaming-distributed as a moving image/sound to the game apparatus 10.

While the exemplary embodiment and the modifications have been described, the description thereof is in all aspects illustrative and not restrictive. It is to be understood that various other modifications and variations may be made to the exemplary embodiment and the modifications.

What is claimed is:

1. A computer-implemented method comprising:
receiving first data based on incident light through an opening provided at a bottom surface of a mouse;
receiving second data based on a posture of the mouse;
accelerating a virtual game object in a virtual space in a specified direction, when the first data indicates that the mouse is being moved in one of a forward direction and a backward direction on a work surface; and
changing a course of the virtual game object being moved, when the second data indicates that the mouse is tilted in a roll direction.

2. The computer-implemented method according to claim 1, comprising reducing a degree of change in the course of the virtual game object in accordance with the second data, until a first condition is satisfied after the virtual game object is accelerated.

3. The computer-implemented method according to claim 2, wherein
the first condition is satisfied by determining that the mouse is brought into contact with the work surface again after having been separated from the work surface.

4. The computer-implemented method according to claim 2, wherein
the first condition is satisfied by elapse of a first specified time from a first timing after the virtual game object has been accelerated.

5. The computer-implemented method according to claim 1, comprising starting acceleration of the virtual game object, when the mouse is separated from the work surface.

6. The computer-implemented method according to claim 1, comprising accelerating the virtual game object in the specified direction, when the first data indicates that the mouse is moved, on the work surface, within a specified angular range including an axis that extends in one of a forward direction and a backward direction of the mouse.

7. The computer-implemented method according to claim 6, comprising accelerating the virtual game object in the specified direction, in accordance with an absolute amount of movement of the mouse on the work surface, based on the first data.

8. The computer-implemented method according to claim 1, comprising displaying, on a display unit, an acceleration-enabled parameter that enables acceleration of the virtual game object in accordance with a remaining amount thereof, the acceleration-enabled parameter being decreased when the virtual game object is accelerated and being recovered upon satisfaction of a second condition.

9. The computer-implemented method according to claim 1, comprising causing the virtual game object to perform a specified action, when the mouse is separated from the work surface during an operation input to an operation unit of the mouse.

10. The computer-implemented method according to claim 9, wherein the specified action is a jump.

11. The computer-implemented method according to claim 9, comprising causing the virtual game object to enter a ready state during an operation input to the operation unit.

12. The computer-implemented method according to claim 11, wherein
the virtual game object is a skateboarder,
the ready state is a crouching state, and
during the ready state, the skateboarder has a greater degree of acceleration or a smaller degree of deceleration than when the virtual game object is not in the ready state.

13. The computer-implemented method according to claim 1, comprising decelerating the virtual game object while the virtual game object is moving, when the second data indicates that the mouse has been rotated in a yaw direction.

14. The computer-implemented method according to claim 1, wherein
the virtual game object is a skateboarder, and
the method comprises causing the skateboarder to kick a ground in the virtual space and causing the skateboarder to accelerate forward, when the first data indicates that the mouse is moved on the work surface in a backward direction.

15. One or more non-transitory computer-readable storage media having stored therein instructions that, when executed, cause one or more processors to perform game operations comprising:
receiving first data based on incident light through an opening provided at a bottom surface of a mouse;
receiving second data based on a posture of the mouse;
accelerating a virtual game object in a virtual space in a specified direction, when the first data indicates that the mouse is being moved in one of a forward direction and a backward direction on a work surface; and
changing a course of the virtual game object being moved, when the second data indicates that the mouse is tilted in a roll direction.

16. The one or more non-transitory computer-readable storage media according to claim 15, wherein
the virtual game object is a skateboarder, and
the game operations comprise causing the skateboarder to kick a ground in the virtual space and causing the skateboarder to accelerate forward, when the first data indicates that the mouse is moved on the work surface in a backward direction.

17. A game apparatus comprising one or more processors and one or more non-transitory computer-readable storage media having stored therein instructions that, when executed, cause the one or more processors to perform operations comprising:
receiving first data based on incident light through an opening provided at a bottom surface of a mouse;
receiving second data based on a posture of the mouse;
accelerating a virtual game object in a virtual space in a specified direction, when the first data indicates that the mouse is being moved in one of a forward direction and a backward direction on a work surface; and
changing a course of the virtual game object being moved, when the second data indicates that the mouse is tilted in a roll direction.

18. The game apparatus according to claim 17, wherein
the virtual game object is a skateboarder, and
the operations comprise causing the skateboarder to kick a ground in the virtual space and causing the skateboarder to accelerate forward, when the first data indicates that the mouse is moved on the work surface in a backward direction.

19. A game system comprising a mouse, one or more processors, and one or more non-transitory computer-readable storage media having stored therein instructions that, when executed, cause the one or more processors to perform operations comprising:
receiving first data based on incident light through an opening provided at a bottom surface of the mouse;
receiving second data based on a posture of the mouse;
accelerating a virtual game object in a virtual space in a specified direction, when the first data indicates that the mouse is being moved in one of a forward direction and a backward direction on a work surface; and
changing a course of the virtual game object being moved, when the second data indicates that the mouse is tilted in a roll direction.

20. The game system according to claim 19, wherein
the virtual game object is a skateboarder, and
the operations comprise causing the skateboarder to kick a ground in the virtual space and causing the skateboarder to accelerate forward, when the first data indicates that the mouse is moved on the work surface in a backward direction.
